(19) United States
(12) Patent Application Publication
(10) Pub. No.: US 2009/0043550 A1
(43) Pub. Date: Feb. 12, 2009

(54) Tessellated Conflict Space Data Fusion Process

(76) Inventor: Lucian Russell, Alexandria, VA (US)

Correspondence Address: GREENBERG & LIEBERMAN, LLC, 2141 WISCONSIN AVE, N.W., SUITE C-2, WASHINGTON, DC, 20007, US

(21) Appl. No.: 12/185,900

(22) Filed: Aug. 5, 2008

Related U.S. Application Data
(60) Provisional application No. 60/954,729, filed on Aug. 8, 2007.

(51) Int. Cl. G06G 7/48

(52) U.S. Cl. 703/6

(57) ABSTRACT

A process of data fusion in potential conflict situations that provides, for the first time, a sound basis for Situation and Impact Assessment, leading to the ability to generate actionable plans and decisions. It uses a uniform representation method for relating time varying objects mapped onto a multi-dimensional space, whether these objects' properties can be either wholly determined or determined only in part. The method provides the best prediction of potential conflicts based on the data and background information available. The method is computationally tractable and scalable. The information generated can be re-used with changed assumptions and alternative courses of action.

This is a nonprovisional of application No. 60/954,729, which was filed on Aug. 8, 2007. Priority is hereby claimed.

This invention was made with Government support under contract F30602-02-C-0143 awarded by the Air Force. The Government has certain rights to this invention pursuant to 37 CFR 401.14, FAR 52.227-11 or FAR 52.227-12.

### FIELD OF THE INVENTION

The present invention is a strategic process that fuses data with a substrate of information by clustering and tessellating, creating new information from which one can determine the likelihood of conflict happening at points in time in a bounded region of a mathematical space and time. In one embodiment it can used by the military for detecting future points of conflict in a campaign; this embodiment uses a substrate of the three dimensions of the real world such as are represented by a military map artifact. Another embodiment is found by considering the substrate to be a manifold, (a mathematical space which in a small region can be approximated as a Euclidean space). An instance of a manifold would be a model of a microscopic view of a blood vessel. A third embodiment is one that uses a substrate of a multiple dimensional space which can be created by selecting any multi-dimensional mathematical function, discrete or continuous, that can usefully model an activity that occurs in time; such examples occur in looking at time series of financial transactions. The process takes the substrate as a given, and adds data defined with respect to the substrate, data inferred to represent one or more objects that can be both mapped to a region of the substrate and have a functional description that maps to other objects and/or the substrate. This latter functional description can be conceptualized as a potential behavior, though no actual intelligence in the object need to be present—it can be a behavior that is due to the laws of physics or of a marketplace. A behavior of an object is defined by its functions that map an instance of the object, via its function's ranges, to other objects and the substrate at a later time.

A conflict exists when the behaviors of different objects, left on their own, result in functional values with respect to the substrate that are in conflict, i.e. cannot jointly exist at a point in time. In a military embodiment two conflicting armies cannot occupy the same hilltop. In a circulatory embodiment a blood clot and a dissolving agent cannot occupy the same space. In a financial embodiment two companies cannot own 51% of a stock. One possible interaction between the data and the substrate is that the objects that generate the data may alter the substrate over time. The process, however, is independent of the data, substrate or embodiment.

### BACKGROUND OF THE INVENTION

The fusion process that is described in this document was originally developed with a military embodiment in mind. The text below describes the background of that embodiment; the combination of processing steps that are the Tessellated Conflict Space Data Fusion Process are not dependent on the particular features of military conflict.

Any fusion process is an instance of a synthetic process and is hence a means to an end. Any technique that performs a synthesis must be judged by how well it supports the end goals. In a military embodiment these are the military objectives of the user, the commander; they are defined by selecting objects that model the composition of the military force and are grouped or clustered together. These objects make the commander's objects a participant. The behaviors expected of the participants are hence determined, specified in the objects by their commanders or by the person setting up the process to be executed for the commander.

In the real world, a commander must interpret the global situation with incomplete and imperfect information and decide on a course of action (COA). Commanders typically have access to intermediary staff analysts, intelligence officers, who assemble and consolidate data, and who reach their own judgments, or situation assessments. But in the end, commanders are their own fusion systems. There is an old saying, “A commander is his best intelligence officer,” for which there is good reason: only the commander fully senses what variations in data are really important.

There is always a tension between commanders who visualize a current and end state and the staff who control conformance to the announced objective and course of action. Intelligence staffs understandably prefer a fixed set of priorities and time windows, established at the beginning of a planning cycle.

As events unfold, however, commanders know that their information requirements will change, and they tend toward a mode of continuous execution rather than one with discrete planning increments. Commanders tend to say, “Give me all the data and I'll decide what's important!” Staff members who are drowning in data, on the other hand, see this as impossible. What's missing in current fusion approaches is a systematic understanding that staff procedures and the currently preferred techniques of both fusion and data smoothing may suppress outlier data in reports (data outside of the expected range of values) that are key to revising interpretations of data and situation assessments. Commanders are very sensitive to exceptions to what they expect. When the exceptions occur, the question always arises as to whether they signify a need to change the assessment and COA. The military has learned over long history that a moderately acceptable COA, vigorously executed, is more likely to succeed than a better COA that is poorly or haltingly executed. Vigorous execution is expected, and staffs control for this. However, major disasters are also created by misjudgment of the situation followed by vigorous execution of the wrong COA. Research has shown that high-performing military units are able to recognize and adapt to changes in the situation, or to the revelation that initial assumptions were false. Poorly performing units, by contrast, blindly adhere to the initial assessment, or vacillate in indecision. One concludes, therefore, that decision aids (and procedures and training) that tease out critical assumptions and sensitive information gaps are important to good initial planning and information requests. They must be systems that interactively can answer questions, and provide an alternative structuring of the data space through data fusion.

In a military embodiment the process is described in terms of its ability to use ST-Box bounding assumptions to allow the specification of an Impact Assessment question to be stated which results in a the ability to perform fusion to create a Situation Assessment. In a non-military embodiment the form of the Impact Assessment will be defined as a range of values in a space-time region that is of interest for the study. The Situation Assessment, a prediction and estimation of the conflict based on the data, will still be a relevant concept.

In any conflict each participant will have less than 100% of the possible information of objects and behaviors of objects (including persons) that could have an impact on the conflict. Therefore as data arrives a less there is a possibility that at any given time predictions of future events will be inaccurate. Thus any process likely to detect the impact of new data sooner is of greater utility than one than ones that have a lesser capability in these regards. For about 20 years in military settings here is an accepted definition of fusion. It is given in the reference below; there are different levels. The process in this patent provides a means to do fusion at level 2 and above. When this is done an information artifact is created, one that can be used to answer many questions or queries. As will be shown, to do the fusion in a manner that is effective for the commander requires looking in advance at the types of queries that can or will have to be answered over time. The baseline of this material is in “Multisensor Data Fusion”, by E. Waltz and J. Llinas, Artech House, 1990.

At a later date, based on about a decade of research into fusion, some more precise definitions were provided by Steinberg et al¹ who define data fusion as “the process of combining data to refine state estimates and predictions,” characterized by five functional levels: ¹ [1] A. Steinberg, C. Bowman, F. White, “Revisions to the JDL Data Fusion Model”, Proc. Of the SPIE Sensor Fusion Architectures, Algorithms, and Applications III, pp 430-441, 1999
Level 0—Sub-Object Data Assessment: estimation and prediction of signal/object observable states on the basis of pixel/signal level data association and characterization
Level 1—Object Assessment: estimation and prediction of entity states on the basis of observation-to-track association, continuous state estimation (e.g. kinematics), and discrete state estimation (e.g., target type and ID)
Level 2—Situation Assessment: estimation and prediction of relations among entities, to include force structure and cross force relations, communications and perceptual influences, physical context, etc.
Level 3—Impact Assessment: estimation and prediction of effects on situations of planned or estimated/predicted actions by the participants; to include interactions between action plans of multiple players (e.g., assessing susceptibilities and vulnerabilities to estimated/predicted threat actions given one's own planned actions).
Level 4—Process Refinement (an element of Resource Management): adaptive data acquisition and processing to support mission objectives. Information Fusion is the subset of data fusion that primarily focuses on situation assessment and impact (threat) assessment activities.

An Information Fusion system is a computer system that can perform fusion at one or more of the levels as defined above.

The example below is now introduced to motivate the need to carefully consider the substrate, in this case of a military embodiment is a map—a Euclidean approximation of the curved surface of the Earth (and thereby an instance of a manifold). We will see that a complex object's location will not be describable as a single point, which motivates the tessellation of the substrate space (the Earth's surface) so that a multi-dimensional region can be described using polytopes.

Example 1 of a context giving rise to a query necessitating a process of data fusion: There are 130 troops in an infantry Company. In an operational setting, it is supposed to “take” some objective. The objective is an area on the Earth; suppose it is a hill. The query is whether it can do so within a given time with enough surviving men, equipment and ammunition to hold the position? The men in the Company must move to that an area and be in control of it. To do so they will walk. In describing this activity mathematically one encounters a challenge of describing where the company is, e.g. their exact place on the map. If the members of the Company are walking on foot in a column they stretch out in a somewhat ragged line that is about ⅕ mile long. If they deploy to take the hill they may be in a straight line, in a semi-circle, or in some terrain-dictated formation. What then is the “location” of the Company?

This question is not easy to answer. One might place it where the commander is located, where radio communications is located, or at the centroid defined by the positions of all the personnel. None of these, however, is an obvious best choice. The problem is really defining what is meant by “location of the Company.”

The Company, however, is a complex or multi-part object and it is not really describable in terms of single point on the Earth's surface. If the location of a complex entity (or object) seems to be too difficult to determine, it would seem logical instead to start with the location of a low-level object, i.e., making a basic inference about the geo-location of a person or vehicle based on its nature, size and movement. However, even this determination cannot be made without considering the context in which the location of that object is a meaningful set of numbers.

In fusion from Level 0 to Level 1 one has a sensor that determines an object from sensor readings; the sensors are pointed in some direction and cover a volume of space. In a military setting, the “location” provided by these sensors might be interpreted as “where to shoot to take it out of action.” However, the precision with which location must be known depends not only on the target, but also on the weapon. To take out an aircraft or a SAM site, one uses an explosive shell so one does not have to be very precise, but the precision required to hit a human target depends quite sensitively on the weapon. A sniper needs to determine a location in centimeters, whereas a shrapnel weapon can be effective within meters. What is meaningful about location is context-dependent, it depends of the queries that are made. In this military embodiment one must have data that answers the questions like “What type of weapon and ammunition will be able to disable X?”

Research into military data fusion has typically been conducted using the conceptual framework of the 5-layer model or its earlier predecessors. In previous work, Bayesian statistics attempts have been made to cluster data for objects from one layer to the next higher layer, beginning with Level 0. However, except in limited cases such as sea warfare with limited numbers of objects with 100% known behaviors, such work has failed to clarify the relationships among objects at levels higher than 1. These relationships, from Level 2, remain poorly understood, particularly as they are needed for Level 3 impact assessments. According to Wikipedia,
Bayes' theorem is a result in probability theory, which relates to probability distributions of random variables. In some interpretations of probability, Bayes' theorem tells how to update or revise beliefs in light of new evidence. The probability of an event A conditional on another event B is generally different from the probability of B conditional on A. However, there is a definite relationship between the two, and Bayes' theorem is the statement of that relationship.

In Bayesian statistics, the probability of the occurrence of an event is estimated from the frequency of previous occurrences. This approach could be suited to military data fusion, which presupposes the accumulation of Level 0 data over time. Moreover, the theory of Bayesian inference nets has been extensively developed over the past 20 years, placing powerful new mathematical tools at the disposal of military data analysts.

However, Bayesian statistics carry the disadvantage of cardinality: the probability of an outcome must be calculated explicitly as a number between 0 and 1. Under actual battlefield conditions one finds that the quality of Level 0 data is frequently inadequate for the accurate calculation even of cardinal Level 1 probabilities. Moreover, when many sources of Level 0 data are combined, slight uncertainties in the data generate major uncertainties in the resulting Level 1 probabilities, often yielding only single-digit accuracy. In practice, Bayesian probabilities may not differ significantly from the value of 0.5 characteristic of complete ignorance.

Baconian Probabilities, in contrast to Bayesian statistics, offer the advantage of ordinality: outcomes are rank-ordered, rather than assigned numerical probability values within the closed interval [0,1]. The Baconian Probabilities provides a means to describe a measurement of the likelihood of data representing an instance of phenomena described as a class. It does this by setting up a set of inductive tests for determining the validity of a hypothesis about an object (“X is a Tank”) or a relationship between objects. A failure of a test negates the hypothesis (this is the accepted definition of how induction works and it was first formulated by Sir Francis Bacon). The usefulness of this approach is that in the absence of data to confirm or deny each test variable it allows partial data to be used to justify a more general conclusion (“maybe an SUV or Car but not a truck”). Baconian Probabilities can be combined by techniques in Fuzzy Logic for use in fusion.

According to Steven D. Kaehler of the Seattle Robotics Society,² Fuzzy Logic is a problem-solving control system methodology that lends itself to implementation in systems ranging from simple, small, embedded micro-controllers to large, networked, multi-channel PC or workstation-based data acquisition and control systems. It can be implemented in hardware, software, or a combination of both. FL provides a simple way to arrive at a definite conclusion set upon vague, ambiguous, imprecise, noisy, or missing input information. FL's approach to control problems mimics how a person would make decisions, only much faster. ²“Fuzzy Logic Tutorial,” http://www.seattlerobotics.org/encoder/mar98/fuz/fl_part1.html#INTRODUCTION

The Baconian method, in combination with Fuzzy Logic, is a more robust approach than Bayesian Probabilities and statistics, giving field commanders more informative insights into situation alternatives.

Example 2: In Afghanistan, Level 1 object assessments reveal a motor vehicle entering a small town; the occupants of the vehicle are clearly firing rifles. One possible Level 2 Situation Assessment (SA) is that Taliban militia are on the attack. However, there is another possibility as well: a traditional Afghan wedding party. One cannot distinguish between these two possible situation assessments on the basis of Level 1 results alone (this exact problem, identified in 2002-2003, has persisted through 2008.)

Currently, lacking an effective system to perform Level 2 and above Fusion, the commander directs his staff to gather data to come to a conclusion for a course of action. The commander asks the staff questions, and the staff provides answers. The local commander himself/herself has a context that determines the scope of the questions. The commander has been delegated some power by the Commander in Chief and the military Chain of Command, so the commander has a directive, e.g. defend, wait, attack, withdraw or observe. Assuming that he will follow the directive there will be a goal to either keep forces in their current position or deploy them. Based on the data what is the Situation, an attack or a neutral event. How the commander assesses the situation depends on the directive. The commander also gives orders to subordinates, and, in so doing, he/she also allocates directives for those command levels. The lower the rank of the officer the more restricted the scope of the command decisions in terms of location and time. The example thereby illustrates an important point: there are time and geo-spatial limits on the activities of each member of the Chain of Command. The queries that each person would make of an Information Fusion System would vary because of this.

Within that scope of decision making it is also the case that the military commander does not wish to be restricted to a single tactical assessment of a situation, because the same data may be interpretable in several different ways. Risks are not all on a continuous scale, because some choices can lead to disastrous consequences. Therefore an effective Information Fusion system would allow for the introduction of a number of hypothetical objects within the area where operations take place, and the projected risks of those assumptions being true needs also to be considered.

The commander's main concern, rather than looking to one “most likely” answer, is clearing his/her mind of doubts that the outliers in the situation portend something unseen and ominous. Thus what is needed is a system that, rather than coming up with a best or most probable answer, can explore arrangements of the data to tease out additional possible answers.

However, this need throws some wrenches into the works of any Information Fusion or synthesis process. A commander will know his/her directive, but cannot be assumed to know that of the opposing commander. While the opponent's directive is still unknown or cannot be confidently estimated, there is no context to aid any fusion process. We can still locate the Level 1 objects, but for a complex object, both its inherent semantics and the semantics of its location (model as object behaviors) cannot be defined if they are few in number and isolated (this was encountered in Iraq where small groups from Sunni Militias and Al Qaeda would jointly mount an attack.) Moreover, this case is likely to be the norm in the future.

When the above points are taken into consideration, one perceives two possible synthetic system approaches for fusion at Level 2 and above. One is to develop a system only for a situation containing a large amount of context—perhaps not as much as would have been needed in the Soviet era, but still with enough information to permit a system to make reasonable guesses about complex entities, e.g., units like platoons. In addition, one could assume only two parties to a conflict and a single directive: both parties could be assumed to be ready to attack, if not already engaged in conflict.

The alternative is to develop a more flexible approach to synthesis. One would assume a situation where there is not much context and that multiple parties needed to be modeled (as in Iraq where civilians are present). That approach was the one taken in the research on the decision process that resulted in this invention. This choice makes the representation of a single object, as well as a complex one, a part of a very large mathematical space, with no particular shape or form. However, by separating and then inter-relating three elements, (1) the substrate, (2) the objects and (3) the queries about their interaction, the dimensionality and extent of the space are both drastically reduced and becomes computationally tractable and of practical use. The novel idea, the unobvious invention, is the way in which the three elements are used together. A historical analogy is the control mechanism that the Wright brothers used to make simultaneous changes to the wing and tail control surfaces to ensure stability during flight.

A key insight opened the door to this new approach: whatever is unknown about an opposing commander's situation is likely to be revealed if no steps were taken, even though the results might be disastrous. This insight focused attention on the fact that the conflict takes place in a time box, and, because of that, also takes place in a 3-D space box. These facts permitted development of a method to constrain the use of data and separately model the substrate to create a mathematical space with a small enough number of dimensions for Information Fusion be practical.

The first step in the process of doing Situation assessment (SA) is to create a conflict model. In the military embodiment the model has a commander who has a directive and is faced with a sequence of events that may necessitate that an action be initiated. For the model the substrate is a limited geo-spatial area and a limited timeframe, representable as a 4-D mathematical region. This is true whether the events are part of a human conflict as in war or a natural conflict, as with a forest fire. In the latter case the behavior on one side is controlled by a human intelligence and on the other by the laws of chemistry and physics. The commander is in control of some resources, objects, that exist within the substrate (occupy a volume at a time.) These resources inherently determine the limits of any timebox in that when they are gone the commander can make no more meaningful decisions about them. In other embodiments the commander's actions are replaces by there decision process such as the laws of physics and chemistry or financial markets.

Although the usual directive for the commander is to safeguard or limit the damage of or injury to the military resources that he/she commands, a very useful insight is provided by looking at the wait directive with no such constraint. In the scenario associated with this directive the commander allows events to take their course but receives information from the resources under his/her command.

Why is the role of commander and the definition of the conflict highlighted in the above discussion? Because it novel when compared to the alternative approaches to fusion. It injects an idea from Layer 3, the conflict, into the process of doing a Situation Assessment, which is supposedly a Layer 2 process. After this is done, Situation Assessment is provided as a necessary byproduct of having Level 1 objects. In other words, Layer 2 does not have an independent existence. It cannot be created without the Layer 3 concepts and context being specified first. When there are embodiments without a commander there are still participants defined as groups of objects. The conflict stems from their behavior.

By contrast starting in the mid 1980s, and continuing over the past two decades, standard layered models—in which each higher layer receives input only from the layer below—have been applied successfully to a variety of computing problems, including telecommunications, operating systems, Ada programming environments, and Enterprise Architecture. The original definition of layers is from the U.S. armed services Joint Directors of Laboratories in 1989. By reading technical articles and books from that period (e.g. E. Waltz cited above) one sees that the concepts of fusion were also influenced by concurrent development and refinement of expert systems led and that to the expectation that higher-level data fusion could be entirely automated within such models. With layered models being so successful in many system development contexts there seemed to be no reason to question application of the standard layered model approach to military data fusion.

This was therefore seemed like a good idea at the time twenty years ago but as we see from the discussion above and the lack of Situation Assessment algorithms today it was clearly wrong. In Example 2 given above, like others revealed by examination of the interpretation problems actually faced by intelligence analysts, one sees that the standard approach to military data fusion becomes unsound at Level 2.

This deficiency is reflected in a key assumption about the assumed role of algorithms, or automated processes for fusion. The standard layered approach assumed that data fusion at all levels only required algorithms for deriving solutions, i.e. no human input to provide any inputs to the process. However the study that led to this invention pointed to a different conclusion. At Level 2 and beyond, data fusion primarily requires the input of people in terms of defining a conflict and the types of questions that must be answered in planning the conflict before one uses algorithms to analyze the data. It is provided by a specification of the queries the system is to answer and the specification of the behaviors of the objects that are to be embedded in the system, mapped to the substrate.

The decision for fusing initial and new data into an Information Fusion (IF) system will use Baconian Probabilities and then Fuzzy Logic. These will generate a database of objects whose data will support a large range of queries about a conflict in a limited region of space and within a limited amount of time.

Based on the nature of the queries, their requirement for granularity and limits in time and space a mathematical space-time substrate is determined. The objects then occupy regions of space over time. The objects are represented with a degree of granularity sufficient to answer the queries. This granularity determines the fine-ness of the tessellation of the time-space model.

Once this is done one now looks at the capabilities of each object. In a military embodiment this can be defined as functions that are defined as either a scalar field or a vector field over a substrate. These are typically measures of visibility, mobility and destructive firepower of each object. The values of these vectors fields then can be added or otherwise combined, perhaps with probabilities, on the tessellated space. That is how the fusion is accomplished. The values of the functions that describe interactions are the data and are defined on the substrate. There they are fused and only on the tiles where there is a conflict; that it why it is possible to build a computationally tractable fusion system. Three elements were mentioned. In this embodiment the substrate (1) is the space-time box. The objects (2) are represented but by means of the functional values over the substrate that describe their role and capability in the conflict. It is the set of queries (3) that defined the degree of tessellation. The mathematics, however, has general applicability and can be applied to other settings, disease and drugs, and financial trading activities. The three parts of the process are what is needed.

A byproduct of the process is when these cannot be specified well enough the system computes a more general solution to the queries which can be provided. This is a novel feature of the process.

### SUMMARY OF THE INVENTION

The present invention is a strategic process for Situation Assessment (“estimation and prediction of relations among entities, to include force structure and cross force relations, communications and perceptual influences, physical context, etc.”), and Impact Assessment (“estimation and prediction of effects on situations of planned or estimated/predicted actions by the participants; to include interactions between action plans of multiple players) that fuses data describing objects' attributes and behaviors with a multi-dimensional mathematical space functioning as a substrate of information (objects in this description are the same as entities in the quote above.) Information in this context refers to the assumption that the mathematical dimensions of the space are models of some real or artificially generated world's potentially, or actually, measurable, or estimate-able, facts or phenomena or processes. The space is a substrate because the objects' existence is predicated upon their having a defined relation to one or more regions of that space. Data is fused when multiple data values are evaluated together to produce a description of the attributes and behavior of a new object or update those of an existing object.

The process is invoked at a given point in time T. The first time the process is invoked the initial data, that received at the start of the process, is used to create object descriptions using a Baconian Probability measure. The more different types of data available the more the number of inductive tests that can be performed, which raises the Baconian Probability that the data represents an instance of a certain class of object. It is the systematic use of different types of data in this manner that justifies the use of the term “fusion”.

The process then provides the answer to a query: a request to predict the likelihood of conflict happening involving those objects' interaction within and upon the substrate at points in time in a bounded region of the mathematical space-time region. Because the region has upper and lower bounds it can accurately be called a space-time box. Mathematically it is, strictly speaking, a polytope, i.e. the generalization to any dimension of polygon in two dimensions. In this case the polygon is a rectangle. The evaluation starts at the time T.

The strategic objective is expressed as an objective function or goal, formulated as a description of objects and their behaviors that are to be located within a certain region of the mathematical space at a given time. The goal is a mathematical formulation of a “directive” or assumption about the behaviors of a group of objects.

A conflict exists when two or more collections of objects cannot have their strategic objective realized at the same time in the same region. Determining the likelihood of conflict is an Impact Assessment. This is determined for times T though the time Tₘₐₓ that is the maximum value of the time-box.

The Situation is the set of objects, identified through the data, that are located on the substrate at a given time. The Assessment of the Situation, given the goals, is the determination of the regions of the space-time box where a conflict will occur and a computation of the likelihood of that conflict. This is the correct definition because if the objects do not conflict then all goals of all groups of objects are achieved and there is no meaningful relationship among the objects or entities.

If the process is started at time T it evaluates the probabilities given the data available at that time. As more data is received at time T1 the Baconian Probabilities of the objects are re-evaluated. This may cause some prior values to be confirmed or dis-confirmed. The prediction of the likelihood of conflict happening is then re-evaluated for the time interval [T1,Tmax]. Alternatively the time box can be re-specified, which means a new query is created.

A novel feature of this process is that when the likelihood of a conflict cannot be predicted with respect to a goal for a region the process computes an alternative region for which a likelihood of a conflict can be predicted.

In summary the process fuses data to provide a Situation Assessment, a prediction of the likelihood of a conflict among groups of objects, said conflict being what determines the relationships among the objects or entities. By changing the Queries or object behaviors one creates new objective functions that can estimate collections of objects that correspond to “force structure and cross force relations, communications and perceptual influences”. Hence it is a process that accomplishes at least Level 2 Fusion.

The present invention is an effective and efficient and scalable process because it avoids making the three assumptions that underlie alternative, and to date generally unsuccessful, approaches to fusion:

1) Bayesian statistics are the clustering method of choice for determining relationships in Level 2 fusion, i.e. Situation Assessment (SA). Instead it uses Baconian Probabilities.
2) Level 2 relationships can be estimated and predicted solely from Level 1 object assessments, and are thus independent of Level 3 Impact Assessments. Instead it starts with Queries about whether certain types of Impacts, defined as conflicts, are likely.

The present invention described herein, the process, is made possible by the use of a novel mathematical model: a new type of dual lattice, one lattice that represents the mathematical space of the functional behavior of objects and another lattice that represents the rectangular polytopes of the multi-dimensional substrate. Given a query which cannot be evaluated “as is” on an element of the dual lattice, one can compute a path thought the nodes to an element that provides the best approximate answer to the query, one that corresponds to the available fused data.

A military embodiment of the use of fusion for this using Baconian Probabilities is illustrated in an example. Suppose a query is made to predict whether the detection of “technical” in Somalia at some location creates a risk to an outpost with one guard (the query maker's objective is to keep the guard alive after a fire-fight and the driver of the technical's assumed objective is to kill the guard.) The technical would be a three-wheeled motorcycle pulling a heavy weapon mounted on a two-wheeled axle.

The (Level 1) sensor readings would detect the five wheels and a weapon, and try to perform a Baconian match on these attributes with those of a jeep or a truck, either of which could have many soldiers and hence be a risk. The match would fail because these vehicles have 4 and 6 wheels respectively. An object on the class of Heavy Weapons would be a tank, but a tank has treads. An artillery piece is not mobile. No object or entity described as a 5-wheel vehicle would be identifiable. Yet the Baconian attributes, wheels and heavy weapon, can be used to create an instance of a new abstract class “Mobile Heavy Weapon”, a superclass of the class containing Tanks. If its path was such that it was predicted as being driven to a battle site it would be assessed as a threat and designated as a target to be destroyed.

When there are multiple objects with very different characteristics then an embodiment of a process for computing a likelihood is the mathematics of Fuzzy Sets. This mathematics is suited to combining abstractions across heterogeneous classes, e.g., the strength of the association of soldiers, weapons, and vehicles as a “fighting force.”

### BRIEF DESCRIPTION OF THE ACCOMPANYING FIGURES

FIG. 1 is a Rendering of a 3-dimensional Terrain File whose digital form is an example of a substrate.

FIG. 2 is a picture of a Terrain and a pie-wedge region where a conflict might occur FIG. 3 depicts many different parts of a jeep that are attached to the frame

FIG. 4 shows a howitzer within a 3×3×3 tessellated cube

FIG. 5 shows two ranges of the functions that describe substrate values in space and time

FIG. 6 shows the four types of mappings of an object that is placed onto a substrate

FIG. 7 shows an example of spatial regions for defense and of potential danger on a map

FIG. 8 shows Blue and Red participants have an objective function to be at the same place

### DETAILED DESCRIPTION OF THE PRESENT EMBODIMENT

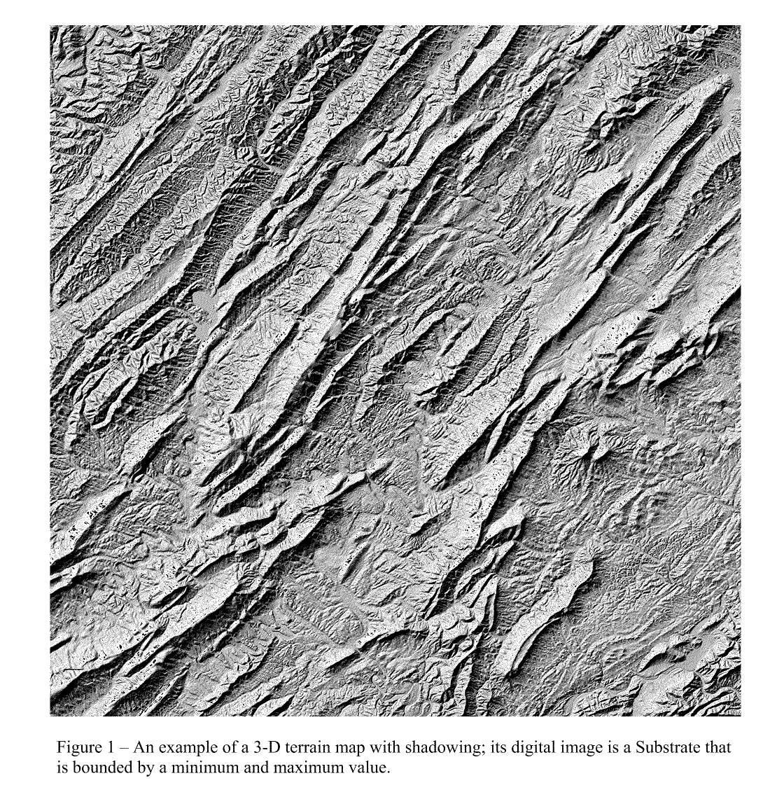

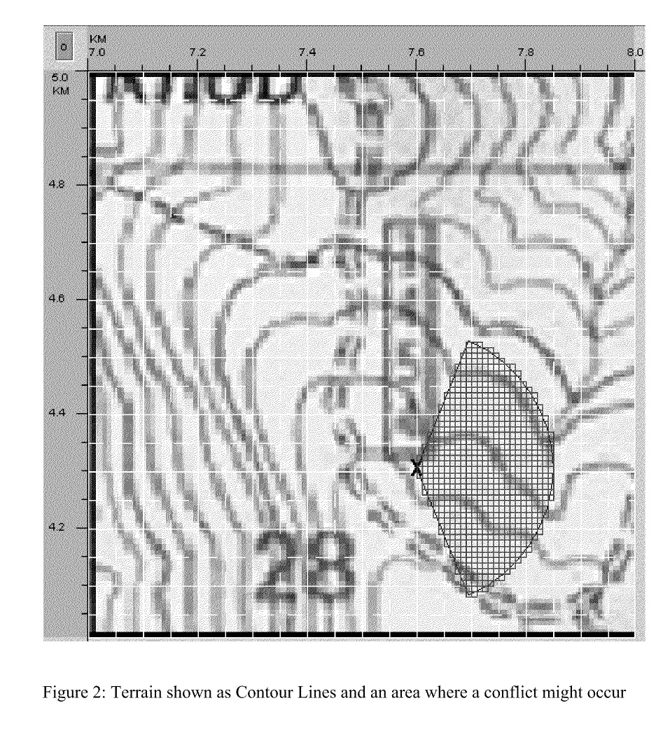

There are a number of assumptions made about the computing environment in which will host the Information Fusion System that uses the invention.
1. There will be a library of objects and classes for those objects which will have been defined previously and are available to the computer system in an object model. These are standard for computer languages like Java, and C++ and C#.
2. The will be a model of the substrate available. One embodiment of such a substrate is that contained in the library of maps in a Geographical Information System (GIS). Another is 3-D terrain files, as rendered in FIG. 1.
3. A human will configure the system for general use by identifying for the computer the sources of all inputs that will be used for data that is to be fused, the formats of that data and any other information needed to make it directly usable by the system.
4. A human will configure the system to accept all the inputs needed by the system during its use and generate all the outputs needed by users of the system during that time. Further there will be sufficient computer security controls in place so that the data is not accessed inappropriately nor tampered with nor computations disrupted.
5. The system will contain all necessary utility programs to generate an ST-Box of the substrate, select objects to be placed in the ST-Box, and select parameters, if needed for the behaviors of the objects.
6. The system will provide the means to automatically make variations in the initial choices made when the system is set up so that many different variations on the fusion scenario can be generated. This include an ability to work in a simulation environment where the system can be initialized with a set of objects that are only hypothesized to exist, and data feeds that are hypothesized to exist in the future.

As the process is a strategic procedure that predicts conflicts among participants it is likely to be executed multiple times. Such an operation would allow the creation of a Statistical sample of outcomes and multiple data sets that describe the movements of the particles over the time interval in the ST-Box.

With this envisioned multiple use of the one process the following nomenclature helps make important distinctions. Each instance of the use of the process with a selection of objects is a tactical instance of the strategy and the collection of all instances investigated determines the outcome of the strategy. In practice a sufficiently large statistical sample of possible tactical instances will be used to evaluate a given strategy. As there may be several ways of creating a tactical instance using the same objects but selecting different parameter values, the individual cases are called operational instances. The selection of objects remains the same.

There are three component sub-processes that must be used together in order to determine the tessellation of the space-time box that will suffice so that all objective functions in a tactical instance can be evaluated at the same time in the same region.

One component sub-processes is the selection of the space-time box. The size of the space time box determines the limits on the tessellation and the selection of objects for the fusion process. Not all objective functions can be evaluated effectively within the constraints of a given space-time box. The space-time box sets the limits of the multi-dimensional regain that will be divided into polytopes. Objects' behaviors will be then be evaluated as scalar or vector values estimated within a polytope. In such computations he value is assigned to the center of gravity of the polytope. Note that for a given sized tiling there may be objects whose behavior cannot be evaluated, a fact that will be determined as the process is completed.

A second component sub-process, the object selection, provides a template of the attributes and behaviors of an object with respect to the constraints of the query. The behavior of an object is specified by means of time varying functions. The range of the function, however, is specified as a minimum tessellation of the space-time box. If the objective function requires an evaluation of multiple function values then the maximum tessellation is a bound on that function. It may cause the Query to evaluate to NULL or provide an alternative answer.

The third process is the query specification. The query has the generic form “What is the value of the objective functions within the given space-time box region given the selection of objects and behaviors and constraints provided?” It thereby implicitly specifies which objects and which of their attributes and behaviors will be selected for a tactical instance, the placement of the objects within the mathematical space at the first time they become part of the space-time box. It may further specify constraints on the objects descriptions or behaviors. If the answer is not “NULL”, a value indicating that the function cannot be evaluated given the assumptions, then one or more sequences of actions within the bounds of the tactical instance are operational instances.

One the three part selection is made a system may generate one or more operational instances of one or more a tactical instances of different queries that can be used to evaluate the likelihood of the strategic goal. The tessellated space defines a scalar or vector field for each one of the ranges of the objects' functions.

All this being said, what exactly is the fusion process? After specifying all of the above one looks at the objects and queries and identifies that there are at least three types of vector fields that can be generated over the tiled substrate:
1. Mobility: the capability to move in the substrate
2. Visibility: the capability to detect and be detected across the E-M spectrum
3. Alterability: in a military context this is the ability to destroy objects or the substrate, e.g. blowing up a bridge of starting a rock slide to block a road. This can be abbreviated as “firepower”, though in other embodiments another word would be more appropriate.

For each tile in each vectors space the effects of all the objects, local or at a distance are added up or otherwise computed. It is the combined set of vector dimension values that determines if a goal or objective of a participant can or likely will be in a region. The likelihood in this case can be computed in an embodiment as a probability the full value of the vector dimension will exist in the tile, e.g. will one artillery shell start a rock slide. Where there is no value for a participant the answer to the query is “NO”.

### The Dual Lattice

The Dual Lattice is the mathematical construct that is used to facilitate the computations. Its elements are related to each other by a partial order. The elements are an object in a class and a rectangular polytope. Thus there are two parts to it, the Object part and the Substrate part. For objects, if Q is a class with N attributes then there are N classes consisting of N-1 attributes, and so forth until the null set, the set of no attributes. From an information perspective the null set is the greatest lower bound of information about an object, and the class is the least upper bound of information. When data for an attribute is lacking the data for the remaining attributes maps the data values to one of the lattice elements with less information. When there are many classes of object there is an upper bound class that is the cross product of all the classes' attributes.

If one has a time box there is a tessellation that is the time-box itself. This is the space that has the minimum spatial information. There are tessellations that can go theoretically to the quantum level, which is the theoretical maximum. Although the classes have a finite number of attributes the ST-Box is a continuous representation. However, any interval sizes that have the ST-box dimensions as integer multiples creates an instance of a lattice element where there is a union of contiguous intervals so that the ST-box is still an integer multiple. One can divide the ST-box by powers of (1/n) to generate a whole family of lattices. So whenever a set of objects is mapped to the substrate it is mapped to one object lattice and one ST-lattice. One by product is that a lesser amount of information about an object means it is likely mapped to larger part of the ST-box. The use of this lattice is a novel innovation.

### The Process Steps

The initial process steps follow:

### The First Step

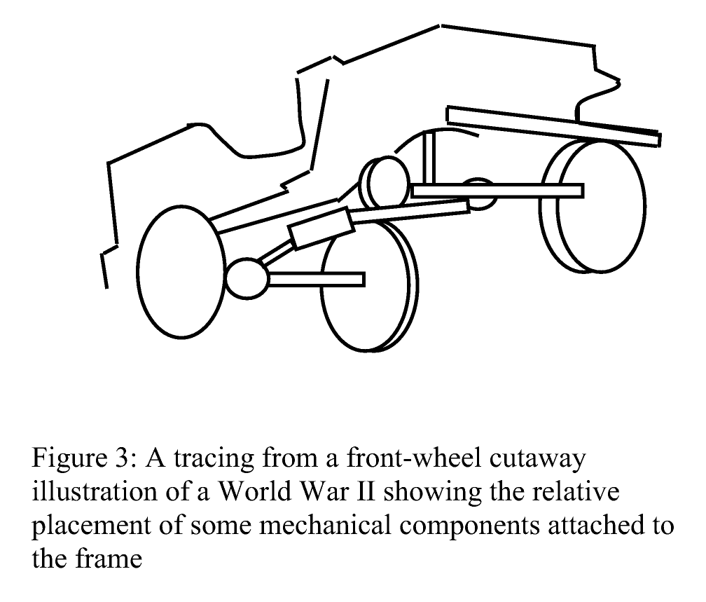

The limits of the substrate's time box are selected, a lower and upper bound of the values of each dimension including time. In the military embodiment it would be the X, Y and Z coordinates of the region of sufficiently large size to represent the region for the queries. FIG. 2 shows a sample region on a map where an observer may be able to see objects.

### The Second Step

This may be done in parallel with the first step.

At initialization (the lower bound of the time box) a set of objects is selected from a library of software objects to be placed on the substrate. These objects are called Spatio-Temporal Referenced Objects; in a military setting they are called Geo-Referenced Information Fusion Objects. They will be abbreviated IFOs. Each software object in the library has a 4-section description of attribute values and the methods or functions that are associated with that software object. The parts are (a) an object identifier (b) an (ordered) set of class attributes, a tuple, (c) a set of inter-object methods that are functions between object-ids that are associated with the tuple, and (d) a set external methods that are functions from the tuple's values, the functional domain, to other tuples, the functional range; these functions include one that has a range that is the substrate. It is also assigned to a time in the time box when it will appear on the substrate.

Let us suppose that N classes of objects will be put onto the substrate. Within each class there will be K(N) different individual objects. For each of those there is a two part process, mapping and evaluating inter-object functions and external functions.

First all those objects that do not have any inter-object methods are chosen. The function that maps to the substrate is assigned values on that substrate, the location. Then the same is done for all objects that have inter-object functions. A range function for each of these is chosen from the library. If they then have mappings to the substrate these values are computed or else assigned. This activity will allows an initial object like a Jeep frame to be selected and placed at a point. Other parts of the Jeep are defined in space using functions that describe their offset from the frame of the jeep, e.g. a gun mounted on a turret in the space in back of the driver. The complex underside of a Jeep is shown in FIG. 3. The location of these parts effects its ability to move over different terrain and the firepower it has implicitly through its personnel or explicitly through an optional mounted gun. Just as the methods that were inter-object must be considered there are methods which map from an object's position in the substrate to another part of the substrate. In a military embodiment this could be the range of a radio, or the range of a weapon, or the radius of the explosion of a shell fired from a weapon.

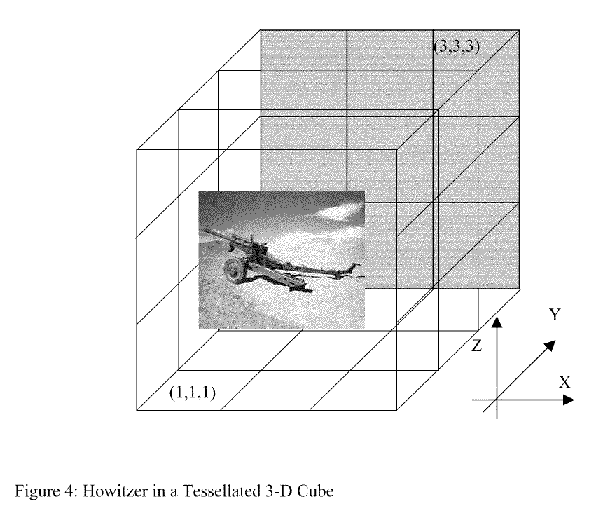

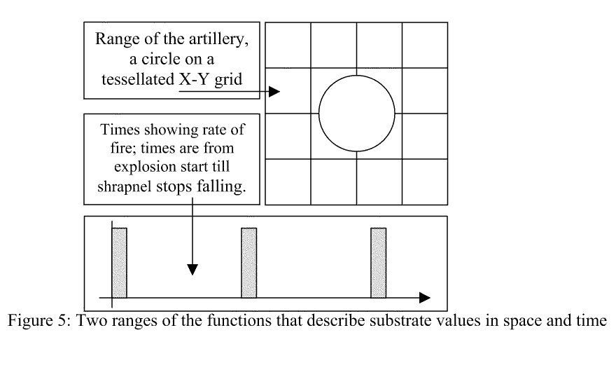

FIG. 4 shows an image of a Howitzer within a set of 3-D polytopes that can contain it. There are nine and by looking at the left face one sees that the image is above the lower edge of the cube. This is because the actual terrain of the substrate is uneven, so the object's position needs to account for this. The reason that less more than one tile is needed brings into view a requirement discussed more in the upcoming description of the query. If the Howitzer is going to be moved then the center polytopes must be of a sufficient width to span the width of the tires. So 27 are needed when it is at rest and maybe only 6 are needed when it is has a slimmer and lower profile when being moved. The function of the howitzer is also to fire shells. When they land they will have a radius in which they will damage the substrate or the objects on it. As the howitzer can be reloaded this is a behavior that is mapped to the substrate at more than one time point. The howitzer therefore has a function that requires mapping the object into a time beyond the initial one. This is shown in FIG. 5.

To summarize once some objects are placed onto the substrate there will be many other objects that will be placed onto the substrate, and many ranges of the substrate that will be in the ranges related to the object's functions.

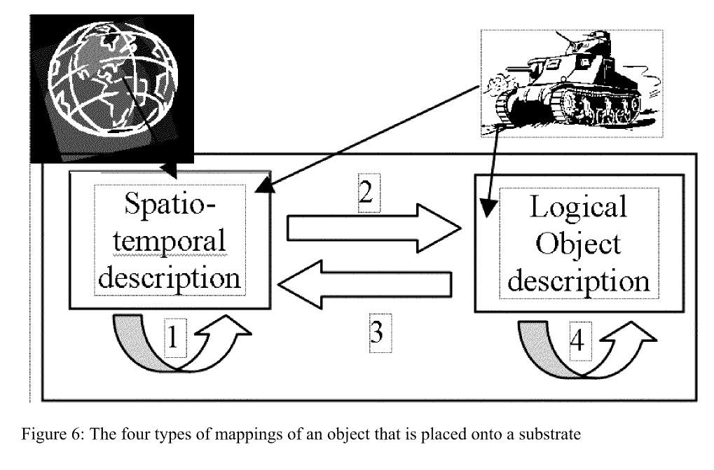

The functions on objects ids are provided because they help represent the reality that some objects are part of other objects. They all will have values once the initial or of each of the main parts of the physical objects are mapped to the substrate: the parts are occupying spatio-temporal regions of a certain size and relative position. The variety of the relationships that can be instantiated this way are illustrated in FIG. 6. In the upper left corner there is a notional figure of a tank. The tank object has many parts which are computed once the tank is located on the substrate. These are shown with the number 4 as a “logical object description”, which is how a person would think of it. The position of the tank and its parts to the substrate are shown with the number 3; they map to regions of the substrate. The regions of the substrate are themselves objects, substrate objects, having a polytope description. Some of them that are created by one object may be connected to another object, which is shown by the number 2 arrow. Then regions may be linked to other regions, as shown by the number 1 arrow.

It is also possible that the mapping of objects to the substrate cannot be done one object at a time. If so an iterative method needs to be applied to allow multiple objects to be mapped together in a way that is consistent with the inter-object functions. One embodiment it to make an approximate mapping and then adjust other mappings. When this is done the objects' descriptions may contain attributes for tolerances for the spatial or temporal relationships among the objects.

In the above it was assumed that enough data was present to create the object descriptions. In a military setting the participant using the system will have the data needed for the objects in his object group but will likely only have partial data for the other participants.

This creation of object mappings to the substrate may not be possible for those that are within groups of other participants, known or presumed known. They can be instantiated in part using the techniques for fusing partial data about objects.

The Third Step If the first step is in parallel, the choices for the ST-Box have to be checked against the set of objects that have been mapped to the substrate and the substrate objects that have been instantiated in the process. Some may be out of range and others may be needed in the range of the ST-box.

### The Fourth Step

This has created the initial conditions, at time “T-zero” for doing fusion. It is possible that the length of time for setting up the objects has meant that some mappings have to be updated to account for the passage of time. If so this is done now.

### The Fifth Step

The objects have been placed on the substrate and but the space has not yet been tessellated. That is the next step. Here the structure of the Lattice comes into play. An initial tessellation can be determined by looking at the intersections of the regions necessary to represent the objects on the substrate and a common dimensional region computed as the intersection of all those, a lowest interval for example in the X, Y and Z co-ordinates. This can be very small, and so an iterative adjustment step can be used to increase the size of some regions so that a larger lowest interval is computed. After a few iterations this should be halted as it is likely that further steps would make some regions too large is they must be an integer multiple of the smallest interval.

At his point, however, a standard technique from Computer Aided Design is used. That discipline of Computer Science when doing computations on solid objects has basic building blocks that are different sizes. So although a 30 centimeter Z-direction is sufficient size interval for all objects that have been mapped to the substrate any polytope that is N*30 cm high can have a new representation that is that height. In other words all polytopes used to represent the objects need not be the same size, just have a dynamically computable common least unit of measure in each dimension.

One now has the polytopes that contain all objects within them. At this point another aspect of the lattice is used.

### The Sixth Step

Although at 8 meter by 8 meter by 8 meter region is of sufficient size to contain a large artillery piece that does not mean that this region is what needs to be used. A region this size is an element of a ST-lattice of 8 meter polytopes. The region however is also one in the lattice of 4 meter and of 2 meter polytopes. These are polytopes of a consistent size. The representation substrate region can be modeled as a collection of contiguous polytopes of a consistent size. That should be done at his step.

The time parameter must now be set. Again this too can be variable, for each object. The Minute provides a useful time minimum.

### The Seventh Step

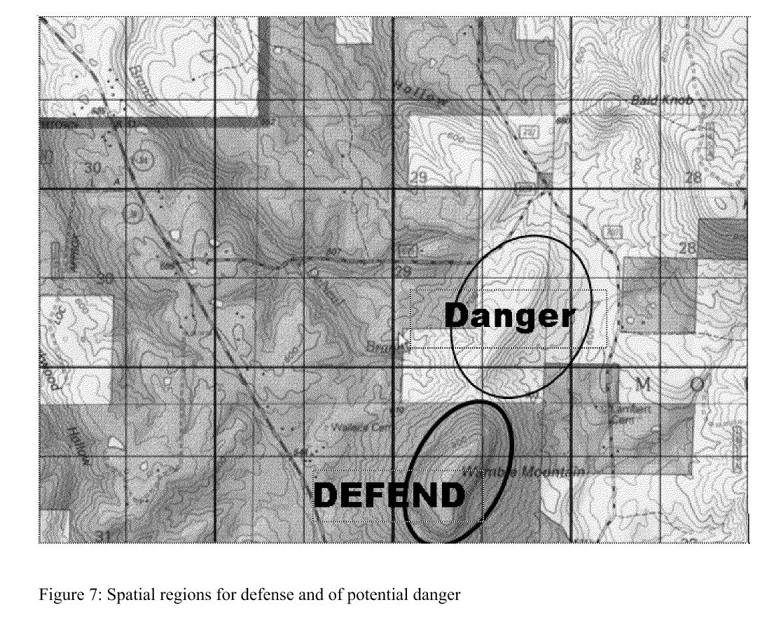

The Query has to be figured in. FIG. 7 shows the type of query of interest in a military embodiment, are there objects that are controlled by a hostile force present in the danger zone that threaten my troops on the hill. Every query says essentially “given the disposition of my objects (as participant) at the given regions of the substrate at a given set of times (for each object) based on actual ands assumed data predict if there is conflict”.

The person in charge of running the system will add objects corresponding to known enemy objects and make an assumption that they will attack the hill if they now it is defended. The objects that show an overlap of perception, Electro-magnetic emissions, that cover most of the ST-box will be evaluated on the defend region, as will the signals from scouts. If there is no conflict the answer is “NO”. If enemy objects are detected then the space will have to be tessellated to create a model that will be useful to determine of the enemy force is so big that the defending force has to withdraw.

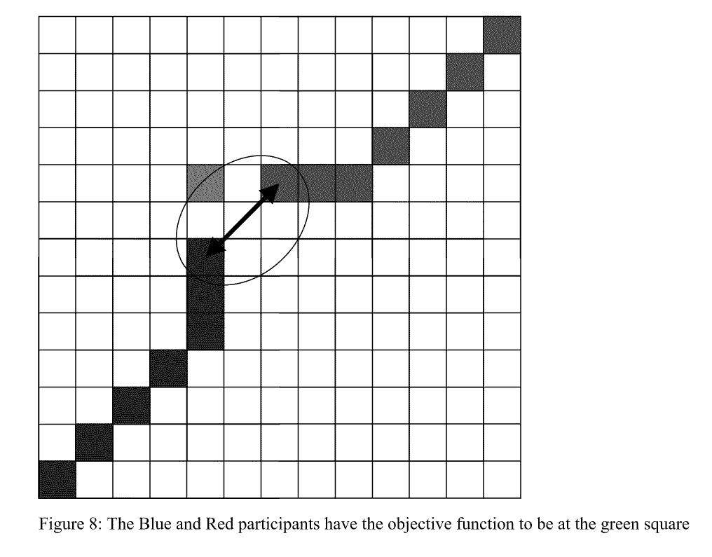

The case of two forces proceeding to the same point is shown in FIG. 8. When they see each other and are in firing range then there is a conflict. The objective function is for each participant, set of objects, to be at the green region. This can engender a fight when they are within firing range.

The query looks at the functions that create vector fields over the tessellation of the ST-box. The polytope size is set by considering the minimum polytope size of the objects in the fifth step, and sets that minimum polytope over the spatial part of the ST-box. It then does the same adjustment of polytope sizes to find a point on the lattice of the ST-box and then breaks the tiles down into contiguous smaller polytopes to represent the actual objects where they are present. In FIG. 2 the red marks show these smaller polytopes that approximate the angled and curved lines.

### The Eighth Step

This is the fusion step. Whatever is known about the objects of other participants' changes over time as data feeds into the system that does the fusion. The data available is matched to various objects and new instances of those objects are mapped to the substrate. As was discussed in the section about the lattice, only a few of the necessary attributes may be known and prior assignments of data to objects may have to change as new information arises. Thus the mapping of objects to the substrate will have to be re-computed to cover all of the data now available. This may cause a revision in the prediction of a potential conflict.

The fusion is likely to be with incomplete data. As partial data can be fused it generates objects from classes with less information, ones that are different object elements on the lattice. Using a Baconian measure if 7 potential types of data are needed to define an object, then an abstract class with 5 attributes is created, and assigned the best substrate region that the attributes allow one to estimate. That creates an element of the lattice. However, it is not isolated. It is related to all other elements on the lattice. The data from all of them can be used in creating values in the scalar and vector fields over the polytopes. That way the partial information is fused with the information that is fully known about objects and their position on the substrate. That is how the best answer to the query is generated. The process takes all the information available. It is mapped to the best class of objects to represent it and related it to the best region of the substrate to which its functions can be mapped.

### The Ninth Step

The system can look at alternatives for possible alternatives and optimizations, local or global (Level 5). There was a mixture of presumed and actual data in the above scenario. The presumed data can be for example be created differently, and active steps like “blow the bridge” can be added. This involves rerunning the system with new data, and the results are there to query in more detail and analyze. As data comes in the system's time parameters in the ST-box can be reset and the query resubmitted.

### The Tenth Step

The use of Fuzzy Sets has not been described yet. These are sets that have a membership function that is not just binary (0/1) but is varying over a range of values. It allows the analyst or commander or other interested party to define ranges of values across the scalar and vectors fields and create a graded set of measures of likelihood corresponding to human judgments.

### Use of Standard Terminology

In what follows we describe a system that embodies the TESSELLATED CONFLICT SPACE DATA FUSION PROCESS described above. The standard computational method of looking at this type of system is to call the object in a polytope or tile a particle. Its values or functional capabilities are assigned to the polytope's center of gravity/. It has been in use for over 40 years and would be used for this type of system. The system is assumed to be initialized and then is running, getting data feeds from the outside. These generate objects whose effects are then computed throughout the scalar and vectors fields over the tessellated ST-Box. The objects on the substrate have functions which detect these changes in the scalar and vector fields. Areas of influence are the polytopes of the tessellation upon which an object's behavior changes a value of a scalar of vector defined on that polytope. A complicated object is one or more objects on the substrate. As scenario is a sequence of changes in the activity of objects over time. The word firepower below is a shorthand for an ability to alter other objects attribute values or functions or the values of the substrate functions. It is assumed the system will not be used unless there is some change of objects on the substrate that occurs over time.

### GLOSSARY

### A

Abstractions=a class that is defined by a set of attributes (the cross products of N mathematical sets) that are created from a given class by the omission of one or more but not all of the N sets in the cross product
Attribute=A specific implicitly indexed instance of a Domain used to define a Class.

### B

Baconian Probability=a procedure that mirrors the inductive process of determining a measure of success in proving a hypothesis; it uses ordinal numbers. If N tests can be used to refute a hypothesis H that there exists an instance of an entity E, then if data exists for all N tests and these are within expected bounds there is a failure to refute the hypothesis. If only M<N tests have data and all M relevant tests are passed then the Baconian Probability is M:N.
Bayesian statistics=A variant of Pascalian mathematical Probability that evaluates the variables of the fundamental equations in a different order, predicting the probability of an event based on the frequency of previous occurrences, and assigning numerical probability values to possible outcomes.
Behavior=The time varying range of functional values of an object, described more precisely as a path in the state space of an object.

Box=A multi-dimensional subset of Euclidean space created by selecting one continuous bounded interval for each dimension.

### C

Class=In mathematics a class is the same as a Set; in Computer Science, the context of this invention, it is a Set that is restricted to being the Cross-Product of a finite number of finite Sets; these latter are called Domains. As a cross product is ordered each instance of a domain is further named an Attribute.
Clustering=The process of identifying multiple objects as being part of a whole, typically but not necessarily because of their proximity or behavior.
Complex entity=An entity defined in a computer system as a set of entities
Complex object=The same as a complex entity An object defined in a computer system as a set of named entities (objects)
Course of Action (COA)=a set of actions that are to be performed by those under the control of a military commander. In a computer model these are specified by the behavior assigned to objects, individually and in a group.

### D

Data Fusion Query (DFQ)=a query incorporating the maximum amount of data
Domain=A Set with a finite number of elements used to approximate an infinite set which includes these elements. One or more instances of a domain are used to form a cross-product that defines a class.

### E

Euclidean Space=a multidimensional mathematical space where each dimension is a subset of the Real Numbers and two parallel lines never intersect.
Entity=The computer science definition: an instance of a Class; the same as an Object.

### F

Function=in mathematics it is a relation wherein some of the sets in the cross product are identified as the domain of the function and the others are the range of the function. For every combination of values in the domains' sets there is one and only one set of values in the sets that are in range's sets.
Fuzzy Logic=system that is based on having a non-binary characteristic function that determines if an element is a member of as set

### G

Geographical Information System (GIS)=system providing geographical information
Geo-referenced=a mapping of the representation of an object to a point on the Earth at a specific time or time interval.

### I

Information Fusion (IF)=The incorporation of data input into a system to determine the existence and properties of one or more objects, simple or complex.
Information Fusion System=is a computer system that can perform fusion at one or more of the levels as defined initially by the Joint Directors of Laboratories.

### L

Lattice=a partially ordered set in which every pair of elements has a unique supremum (the elements' least upper bound; called their join) and an infimum (greatest lower bound; called their meet).
Likelihood=a mathematical measure that is used to estimate whether when a certain variable may or may not be equal to a given value. In Pascalian or Bayesian Probability it is a number in the Real Number interval [0,1].

### M

Manifold=a mathematical space which in a small region can be approximated as a Euclidean space

### O

Object=The Computer Science meaning of object is an instance (or instantiation) of a class. The class object contains a combination of data and the instructions that operate on that data, making the object capable of receiving messages, processing data, and sending messages to other objects.
Outliers=data whose values lie outside of a range of expected values

### P

Participant=A designated set of objects that are defined in an S-T Box.

### R

Relation=in mathematics a subset of a cross product of sets.

### S

Situation Assessment (SA)=estimation/prediction of relations among entities
SAMsite=Surface to Air Missile site
Scalar field=mathematical term for a N-dimensional matrix the entries of which are single numbers (scalars).
Software Object=In object-oriented programming, a software object is an instance (or instantiation) of a class. The class object contains a combination of data and the instructions, called methods, that operate on that data, making the object capable of receiving messages, processing data, and sending messages to other objects.
Spatio-temporal region=a geographical region bound within a finite time interval
State Space=for an object that is the domain of an set of functions that change over time it is the mathematical space consisting of those values and their first and second or higher derivatives, approximated if necessary by assuming a continuous behavior within time intervals for which no data value is present.
ST Box=Space/Time Box: a bounded sub-set of a four dimensional Euclidean space where one of the dimensions represents time.
Substrate=a multi-dimensional mathematical space that is common to all objects' descriptions and functional ranges. It is a sub-set of the set of all Domains common to the objects.

### T

Tessellation=a standard mode of dividing a Box into a set of polytopes whose union as sets is the box. The polytopes intersect only at their boundaries.

### V

Vector-Field=the equivalent of a scalar field except that an ordered sequence of numbers, a vector, is associated with each point instead of a single number (scalar).

1. A system for looking for a conflict of a point in space, comprising:
detecting movement of particles in response to a first object moving; and
looking for overlaps between the particles.

2. A system for detecting when the areas of influence of objects intersect over time, comprising:
detecting movement of particles in response to one another;
obtaining coordinates of a first complicated object;
obtaining coordinates of a second complicated object;
recognizing scenarios in which said first complicated object and said second complicated object might conflict based upon the movement of the particles in response to one another.

3. The system of claim 2, further comprising applying visibility variables.

4. The system of claim 2, further comprising applying velocity variables.

5. The system of claim 2, further comprising applying firepower variables.

6. The system of claim 3, further comprising applying velocity variables.

7. The system of claim 3, further comprising applying firepower variables.

8. The system of claim 4, further comprising applying firepower variables.

9. The system of claim 2, further comprising modeling scenarios in a computationally discrete tractable ization.

10. The system of claim 2, further comprising applying computation magnitude and duration.

11. The system of claim 3, further comprising applying computation magnitude and duration.

12. The system of claim 4, further comprising applying computation magnitude and duration.

13. The system of claim 5, further comprising applying computation magnitude and duration.

14. The system of claim 6, further comprising applying computation magnitude and duration.

15. The system of claim 7, further comprising applying computation magnitude and duration.

16. The system of claim 8, further comprising applying computation magnitude and duration.

17. The system of claim 9, further comprising applying computation magnitude and duration.

18. The system of claim 2, further comprising obtaining coordinates for at least one other object associated with the first complicated object.

19. The system of claim 2, further comprising obtaining coordinates for at least another object associated with the second complicated object.

20. The system of claim 18, further comprising obtaining coordinates for at least another object associated with the second complicated object.

21. The system of claim 9, further comprising:
measuring the computationally discrete tractable ization to determine a point at which further information is no longer useful; and
limiting the computationally discrete ization to the point.

22. The system of claim 9, further comprising:
replacing the first or second complicated object with a standard object; and
modifying interaction functions to react with the standard object.
